(19) United States
(12) Patent Application Publication
(10) Pub. No.: US 2015/0123050 A1
(43) Pub. Date: May 7, 2015

(54) Positive-Electrode Active Material and Power Storage Device

(71) Applicant: Semiconductor Energy Laboratory Co., Ltd., Kanagawa-ken (JP)

(72) Inventors: Shunpei Yamazaki, Tokyo (JP); Tamae Moriwaka, Isehara (JP); Takuya Hirohashi, Atsugi (JP); Kuniharu Nomoto, Atsugi (JP); Takuya Miwa, Atsugi (JP)

(73) Assignee: Semiconductor Energy Laboratory Co., Ltd.

(21) Appl. No.: 14/589,455

(22) Filed: Jan. 5, 2015

Related U.S. Application Data
(62) Division of application No. 13/242,135, filed on Sep. 23, 2011.

(30) Foreign Application Priority Data
Oct. 8, 2010 (JP) 2010-228634

(51) Int. Cl. H01M 4/58; H01M 4/62

(52) U.S. Cl. CPC H01M 4/5825; H01M 4/625; H01M 2220/30
USPC 252/521.2; 252/521.3

(57) ABSTRACT

A positive-electrode active material with improved electrical conductivity, and a power storage device using the material are provided. A positive-electrode active material with large capacity, and a power storage device using the material are provided. A core including lithium metal oxide is used as a core of a main material of the positive-electrode active material, and one to ten pieces of graphene is used as a covering layer for the core. A hole is provided for graphene, whereby transmission of a lithium ion is facilitated, resulting in improvement of use efficiency of current.

This application is a divisional of copending U.S. application Ser. No. 13/242,135, filed on Sep. 23, 2011 which is incorporated herein by reference.

### TECHNICAL FIELD

The present invention relates to a positive-electrode active material and a power storage device.

### BACKGROUND ART

The field of portable electronic devices such as personal computers and mobile phones has progressed significantly. The portable electronic devices have needed a chargeable power storage device having high energy density, which is small, lightweight, and reliable. As such a power storage device, for example, a lithium-ion secondary battery is known. In addition, development of electric vehicles equipped with secondary batteries has also been progressing rapidly in response to growing awareness to environmental problems and energy problems.

As a positive-electrode active material in a lithium-ion secondary battery, a phosphate compound having an olivine structure and containing lithium (Li) and iron (Fe), manganese (Mn), cobalt (Co), or nickel (Ni), such as lithium iron phosphate (LiFePO₄), lithium manganese phosphate (LiMnPO₄), lithium cobalt phosphate (LiCoPO₄), or lithium nickel phosphate (LiNiPO₄), is known for example (see Patent Document 1, Non-Patent Document 1, and Non-Patent Document 2).

### REFERENCE

### Patent Document

Patent Document 1: Japanese Published Patent Application No. H11-25983

### Non-Patent Document

Non-Patent Document 1: Byoungwoo Kang, Gerbrand Ceder, “Nature”, 2009, Vol. 458 (12), pp. 190-193
Non-Patent Document 2: F. Zhou et al., “Electrochemistry Communications”, 2004, Vol. 6, pp. 1144-1148

### DISCLOSURE OF INVENTION

The bulk electrical conductivity of a phosphate compound having an olivine structure is low, and it is difficult for a single particle to provide characteristics high enough as an electrode material.

Therefore, a method for improving the electrical conductivity, in which a thin carbon layer is formed on the surface of a particle, a so-called carbon coating method has been proposed. However, in order to provide a sufficient electrical conductivity, it is necessary that the carbon layer is thick; thus, the carbon layer accounts for several tens of percent or more of the positive-electrode active material by volume, which causes reduction in the battery capacity.

In view of the foregoing, one object of one embodiment of the present invention is to provide a positive-electrode active material with improved electrical conductivity and higher current use efficiency, and a power storage device using the material.

It is one object of one embodiment of the present invention to provide a positive-electrode active material whose capacity per unit weight or unit area is large, and a power storage device using the material.

One embodiment of the present invention is a positive-electrode active material and a power storage device. Details thereof will be described below.

One to ten pieces of graphene is used to cover a core which is a main material of a positive-electrode active material, so that the thickness of a covering layer can be reduced and the electrical conductivity of the positive-electrode active material can be increased. Further, a hole is formed in the graphene, through which a lithium ion can pass, so that insertion/extraction of an lithium ion into or from the positive-electrode active material is facilitated, resulting in improvement of the charge/discharge rate of the power storage device, which enables electrical charging/discharging in a short period of time.

According to one embodiment of the present invention, one to ten pieces of nanographene is used to cover a core which is a main material of a positive-electrode active material, so that the thickness of a covering layer can be reduced and the electrical conductivity of the positive-electrode active material can be increased. Further, the nanographene is provided with a space, through which a lithium ion can pass. That is, there is a region of the surface of the core (e.g., lithium metal oxide) which is a main material of the positive-electrode active material, which is not covered with the nanographene, so that insertion/extraction of an lithium ion into or from the positive-electrode active material is facilitated, resulting in improvement of the charge/discharge rate of a power storage device, which enables electrical charging/discharging in a short period of time.

In this specification, graphene and nanographene each refer to a sheet of carbon molecules of one atomic layer having sp² bonds. As the number of pieces of graphene or nanographene to be overlapped increases, the electrical conductivity is improved. However, a stack of 11 or more pieces of graphene or nanographene results in too strong graphitic characteristics and is not preferable; in addition, the thickness thereof is over the thickness as small as negligible. One piece of graphene or nanographene is about 0.34 nm.

Further, graphene and nanographene each feature the high electrical conductivity. Accordingly, the electrical conductivity of the positive-electrode active material can be increased.

Further, since the hole is provided in the one to ten pieces of graphene or the space is provided in the one to ten pieces of nanographene so that a lithium ion can pass therethrough from the main material of the positive-electrode active material, such as the lithium metal oxide, the use efficiency of current can be increased.

One embodiment of the present invention is a power storage device including a positive electrode in which a positive-electrode active material is provided over a positive-electrode current collector and a negative electrode which faces the positive electrode with an electrolyte provided therebetween. The positive-electrode active material includes a core including lithium metal oxide and a covering layer which covers the core and includes one to ten pieces of graphene. A hole is formed in the covering layer.

In the above-described structure, the hole may be formed by bonding an oxygen atom to part of carbon atoms in the graphene.

One embodiment of the present invention is a power storage device including a positive electrode in which a positive-electrode active material is provided over a positive-electrode current collector and a negative electrode which faces the positive electrode with an electrolyte provided therebetween. The positive-electrode active material includes a core including lithium metal oxide and a covering layer which covers the core and includes one to ten pieces of nanographene. The covering layer covers the core with a space in the nanographene.

In the above-described structure, the covering layer may include amorphous carbon.

According to one embodiment of the present invention, a positive-electrode active material with high electrical conductivity can be obtained. Further, with the positive-electrode active material, a power storage device with large discharging capacity per unit weight or unit area can be provided.

### BRIEF DESCRIPTION OF DRAWINGS

In the accompanying drawings:

FIGS. 1A and 1B are a cross-sectional view of a positive-electrode active material (particle) and a pattern diagram of graphene having a hole;

FIG. 2 is a pattern diagram of graphene;

FIGS. 3A and 3B are calculation results of potential energy with respect to a distance between graphene and a lithium ion;

FIGS. 4A to 4H illustrate a manufacturing method of a positive-electrode active material;

FIGS. 5A and 5B are cross-sectional views of positive-electrode active materials (particles);

FIG. 6 illustrates a lithium-ion secondary battery;

FIGS. 7A and 7B illustrate application examples of a power storage device;

FIG. 8 is a perspective view illustrating one application example of a power storage device;

FIG. 9 illustrates an application example of a power storage device.

### BEST MODE FOR CARRYING OUT THE INVENTION

Hereinafter, embodiments of the present invention will be described with reference to drawings. Note that the present invention is not limited to the following description and it will be readily appreciated by those skilled in the art that modes and details thereof can be modified in various ways without departing from the spirit and the scope of the present invention. Structures of different embodiments among the embodiments can be combined to implement as appropriate. In the description of the present invention, a reference numeral indicating the same part or a part having a similar function is used in common in the specification, and the repeated description thereof is omitted.

Note that the position, the size, the range, or the like of each structure illustrated in the drawings and the like is not accurately represented in some cases for easy understanding. Therefore, the present invention is not necessarily limited to the position, size, range, or the like as disclosed in the drawings and the like.

In addition, in this specification, ordinal numbers such as “first”, “second”, and “third” are used in order to avoid confusion among components, and the terms do not mean limitation of the number of components.

### Embodiment 1

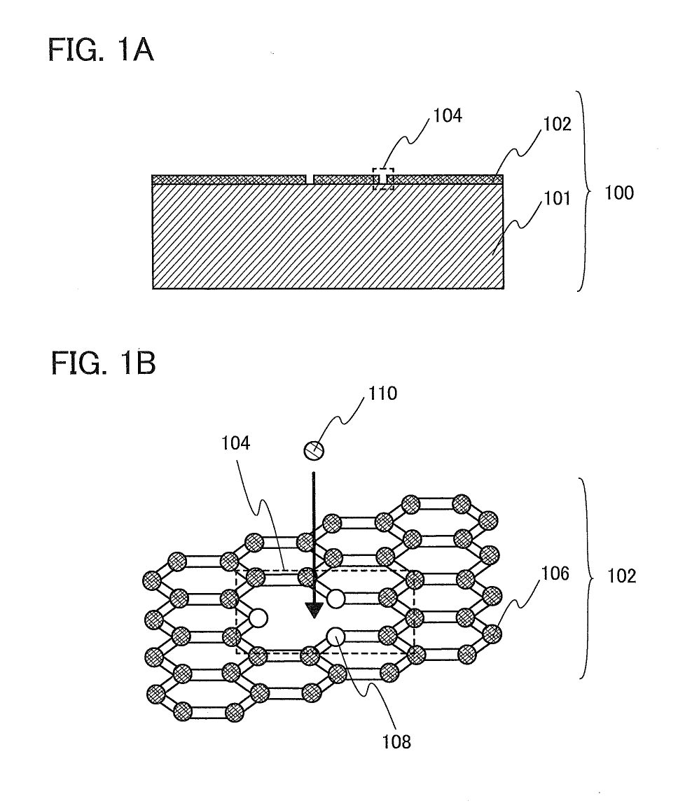

In this embodiment, a structure of a positive-electrode active material which is one embodiment of the present invention will be described with reference to FIGS. 1A and 1B.

FIG. 1A is a cross-sectional view of a positive-electrode active material 100 which is one embodiment of the present invention.

The shape of the positive-electrode active material 100 is not particularly limited, and is preferably a particle shape. In the cross-sectional view of FIG. 1A, the shape is flat because the outermost surface of the positive-electrode active material is illustrated microscopically.

The positive-electrode active material 100 shown in FIG. 1A includes a core 101 containing lithium metal oxide as a main component, a covering layer 102 which covers the core 101, and a hole 104 formed in the covering layer 102.

In FIG. 1A, the core 101 which is a main component of the positive-electrode active material, the covering layer 102, and the hole 104 in the covering layer 102 are collectively referred to as a positive-electrode active material.

Examples of the core 101 containing lithium metal oxide as a main component are lithium iron phosphate (LiFePO₄), lithium nickel phosphate (LiNiPO₄), lithium cobalt phosphate (LiCoPO₄), and lithium manganese phosphate (LiMnPO₄).

As the core 101 containing lithium metal oxide as a main component, Li₂FeSiO₄, Li₂MnSiO₄, LiCoO₂, LiNiO₂, LiCoₓMn_{y}Ni_{z}O₂(x+y+z=1), or spinel LiMn₂O₄ may be used as well.

The covering layer 102 is formed using one to ten pieces of graphene.

The covering layer 102 is provided as shown in FIG. 1A, whereby the electrical conductivity of the positive-electrode active material 100 can be improved. Further, the positive-electrode active materials 100 are in contact with each other with the covering layers 102 provided therebetween, whereby the positive-electrode active materials 100 are electrically connected to each other, which leads to further improvement in the electrical conductivity of the positive-electrode active material 100.

FIG. 1B is a pattern diagram where the covering layer 102 and the hole 104 are modeled further microscopically.

In FIG. 1B, a carbon atom 106, an oxygen atom 108, and a lithium ion 110 are shown. In FIG. 1B, graphene which is the covering layer 102 has a single layer structure where the oxygen atom 108 terminates a dangling bond of the carbon atom 106 in a part of bonding of the carbon atom 106. That is, the hole 104 is formed by bonding the oxygen atom 108 to the vacancy of the carbon atom 106 in the graphene.

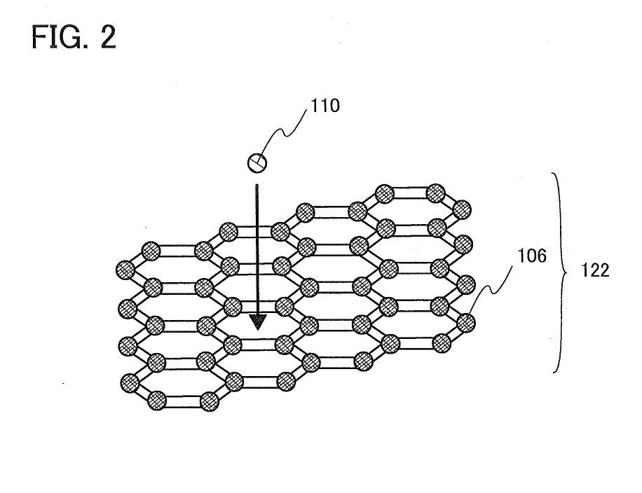

Calculation was performed on whether the lithium ion 110 can pass through the hole 104 in the structure shown in FIGS. 1A and 1B. First, a structure which is not provided with the hole 104, unlike the structure of FIG. 1B, was considered. FIG. 2 is a pattern diagram of graphene which is a covering layer 122 which is not provided with the hole 104. FIG. 2 illustrates graphene which consists of the carbon atoms 106.

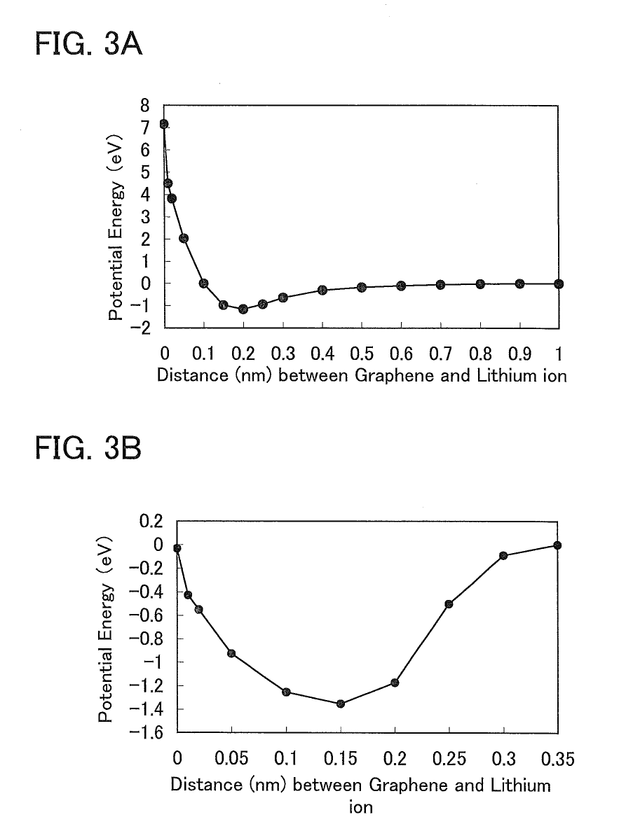

With respect to the periodic structure shown in FIG. 2, an electrical charge of +1 was supplied to the whole of the structure and a distance r between graphene and lithium ion was changed, under which the change of the potential energy in the whole system was calculated. The calculation result is shown in FIG. 3A.

In FIG. 3A, the vertical axis indicates the potential energy (eV) and the horizontal axis indicates the distance (nm) between graphene and lithium ion. In FIG. 3A, assuming that the interaction therebetween vanishes at a distance of 1 nm between graphene and lithium ion, the relative energy change from the distance at r=1 nm is shown with the distance at r=1 nm as a reference (0 eV). First-principles calculation software using a plane-wave pseudopotential method, CASTEP (produced by Accelrys Software Inc.) was used for the calculation.

From FIG. 3A, when the distance r between graphene and lithium ion is larger than 0.2 nm, weak attraction serves, and the potential energy is the minimum at around r=0.2 nm. However, as the distance between graphene and lithium ion decreases from 0.15 nm, the repulsion between atomic shells of the carbon atom 106 and the lithium ion 110 is increased as compared to the attraction; as a result, the repulsion serves as a whole, which increases the potential energy.

Then, at r=0 nm, that is, when the lithium ion is passing through the graphene, the potential energy (energy barrier) required is 7.2 eV. Considering the voltage of a general lithium-ion battery is about 5 V, it is difficult that a lithium ion passes through graphene.

On the other hand, with respect to the graphene which is the covering layer 102 provided with the hole 104 shown in FIG. 1B, an electrical charge of +1 was supplied to the whole of the structure and a distance r between graphene and lithium ion was changed, under which the change of the potential energy in the whole system was calculated. The calculation result is shown in FIG. 3B.

In FIG. 3B, the vertical axis indicates the potential energy (eV) and the horizontal axis indicates the distance (nm) between graphene and lithium ion. In FIG. 3B, the relative energy change from a distance at r=0.35 nm is shown with the distance at r=0.35 nm as a reference (0 eV), which is a difference from FIG. 3A. The calculation at the distance larger than r=0.35 nm was omitted for burden for calculation because the potential energy (eV) less changed at the distance larger than r 0.35 nm in FIG. 3A and the change of the potential energy was already small at the distance of r=0.35 nm in FIG. 3B.

From FIG. 3B, when the distance r between graphene and lithium ion is larger than 0.15 nm, attraction is the dominant force. However, as the distance between graphene and lithium ion decreases from 0.15 nm, the repulsion between atomic shells of the carbon atom and the lithium ion is increased as compared to the attraction; as a result, the repulsion serves as a whole. The potential energy at r=0 nm is substantially equal to that at r=0.35 nm; accordingly, no additional energy is required when the lithium ion is passing through the graphene. That is, no energy barrier exists when the lithium ion is passing through the graphene. Consequently, the lithium ion can readily pass through the graphene sheet.

As described above, with the hole 104 in the graphene which is the covering layer 102, a lithium ion can readily pass through the covering layer 102 from the core 101 which is a main material of the positive-electrode active material 100. Accordingly, in a power storage device using the positive-electrode active material of this embodiment, with the hole in the graphene, through which the lithium ion can pass, insertion/extraction of the lithium ion is facilitated, resulting in improvement of the charge/discharge rate of the power storage device, which enables electrical charging/discharging in a short period of time.

Accordingly, a positive-electrode active material with high use efficiency of current, a positive-electrode active material with large capacity per unit area, and a power storage device using the positive-electrode active material can be provided.

### Embodiment 2

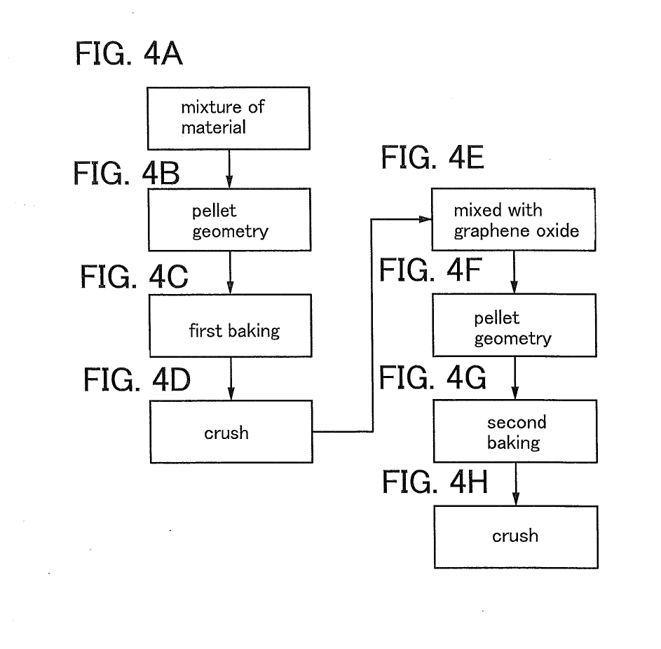

Next, an example of a method for manufacturing a positive-electrode active material of a power storage device of one embodiment of the present invention will be described using FIGS. 4A to 4H.

Hereinafter, a method for manufacturing a core 101 containing a lithium metal oxide as a main material, a covering layer 102, and a hole 104 is described.

Examples of the core 101 including a lithium metal oxide as a main material are LiFePO₄, LiNiPO₄, LiCoPO₄, LiMnPO₄, Li₃V₂(PO₄)₃, Li₂FeSiO₄, Li₂MnSiO₄, and the like.

For example, in the case where LiFePO₄ is used as a main material of the positive-electrode active material, Li₂CO₃, FeC₂O₄.2H₂O, and NH₄H₂PO₄ that are raw materials are crushed into crumbs with a ball mill with the use of acetone as a solvent and uniformly mixed (see FIG. 4A). With the ball mill treatment, the compounds can be not only mixed but also microparticulated, which leads to microparticulation of LiFePO₄. In addition, with the ball mill treatment, the compounds can be uniformly mixed, which leads to improvement of the crystallinity of the material for the electrode. Although acetone is described as the solvent, ethanol, methanol, or the like can be used as well.

Next, the mixture of the raw materials is compacted into a pellet geometry (see FIG. 4B), and first baking is performed thereon (see FIG. 4C). The first baking is performed, for example, under an inactive atmosphere (e.g., N₂ or a rare gas), a reducing atmosphere (e.g., H₂), or a reduced pressure at a temperature in the range of 250° C. to 450° C. for 1 to 48 hours. With the first baking, the mixture of the raw materials is reduced to particles whose particle sizes are almost the same so as to be appropriate for the following reaction. In this specification, the reduced-pressure atmosphere refers to the atmosphere where the pressure is 10 Pa or less.

Next, the pellet that is the mixture of the raw materials is crushed (see FIG. 4D), and is mixed with graphene oxide into acetone with a ball mill (see FIG. 4E). As the size of the mixture of the raw materials is smaller, the particle size of the positive-electrode active material becomes smaller. In this embodiment, it is prepared such that the particle size of the positive-electrode active material becomes less than or equal to 50 nm.

It is preferable that the particle size of the core of the main material of the positive-electrode active material be small. As the particle size of the core is smaller, the surface area of the positive-electrode active material is larger, resulting in improvement of the charging/discharging characteristics.

However, as the particle size of the core of the main material of the positive-electrode active material is smaller, the thickness of the layer which covers the core becomes a problem. For example, in the case where the particle size of the core of the main material of the positive-electrode active material is 50 nm and baking the core is performed with a carbon compound such as sugar on the core to cover the core with carbon, the thickness of carbon that is the covering layer is about 5 nm to 8 nm. In that case, the total particle size of the core and the covering layer is about 60 nm, which is 1.2 times as large as the particle size before covering.

On the other hand, in the case where the covering layer of the core of the main material of the positive-electrode active material is, for example, one piece of graphene, whose thickness is about 0.34 nm, the total particle size of the core and the covering layer is less than 51 nm when the particle size of the core of the main material of the positive-electrode active material is 50 nm; thus, the volume and weight of the positive electrode are not increased so much.

Next, the mixture including graphene oxide is compacted into a pellet geometry (see FIG. 4F), and second baking is performed thereon (see FIG. 4G). The second baking is performed, for example, under an inactive gas atmosphere containing no oxidized gas such as oxygen, preferably under a reducing gas atmosphere or in a vacuum. It is preferable that the temperature of the second baking be 500° C. to 800° C. and the baking time be 1 to 48 hours. With the second baking, the reaction of the mixture of the raw materials is completed, so that particulate LiFePO₄ can be obtained, and graphene oxide is reduced to cover the LiFePO₄ particle with the covering layer of graphene. As the mixture fraction of graphene oxide is increased, the number of pieces of graphene to be overlapped is increased. The mixture fraction of graphene oxide may be determined such that the number of pieces of graphene to be overlapped becomes 1 to 10 pieces. If the second baking is performed without performing the first baking, the particle size of the LiFePO₄ particle becomes too large in some cases.

Next, the pellet subjected to the second baking is crushed (see FIG. 4H). In this manner, the positive-electrode active material is obtained.

Graphene oxide can be manufactured by separating a layer from graphite oxide. For example, graphite oxide can be manufactured using a modified Hummers method. It is needless to say that the manufacturing method of graphite oxide is not limited thereto; for example, a Brodie method, a Staudenmaier method, or the like can be employed as well. According to the modified Hummers method, concentrated sulfuric acid and potassium permanganate salt are used to oxidize graphite. Further, according to the Brodie method, nitric acid and potassium chlorate are used to oxidize graphite; according to the Staudenmaier method, nitric acid, sulfuric acid, and potassium chlorate are used to oxidize graphite. Hereinafter, an example of the manufacturing method of graphite oxide according to the modified Hummers method, and an example of the manufacturing method of graphene oxide are described.

First, single-crystal graphite powder is put into concentrated sulfuric acid, and the mixture is stirred with ice bath. Next, potassium permanganate salt is added slowly, and the mixture is stirred and reacted at 35° C. for 30 minutes. Then, a small amount of pure water is added slowly and the mixture is reacted at 98° C. for 15 minutes. After that, in order to stop reacting, pure water and a hydrogen peroxide solution are added thereto, and the mixture is filtered to provide a reaction product, graphite oxide. That graphite oxide is cleaned with pure water and 5% dilute hydrochloric acid, dried, and then dissolved with pure water at a concentration of 0.2 mg/ml. The obtained solution is applied with ultrasonic waves for 60 minutes, and is subjected to centrifugation at 3000 rpm for 30 minutes. The resultant clear supernatant liquid is a graphene oxide dispersion aqueous solution. Graphene oxide can be obtained by applying ultrasonic waves to graphite oxide and separating a layer thereof. Graphite oxide is easier to separate than graphite since the space between layers thereof is wider.

This embodiment, where graphene oxide is reduced and the core that is the main material of the positive-electrode active material is synthesized in the same step, provides an advantage of shortening of the manufacturing process.

In this manner, with the use of graphene oxide, a hole where a carbon atom which is part of graphene that is the covering layer is bonded with an oxygen atom can be formed at the reduction of graphene oxide.

A conduction aid may be kneaded into the obtained positive-electrode active material, so that the mixture may be used as a positive-electrode active material. In that case, the mixture fraction is set such that the conduction aid accounts for the amount greater than or equal to 0 weight % and less than or equal to 1 weight % of the total positive-electrode active material. As the mixture fraction of the conduction aid is decreased, the volume and weight of the resultant positive-electrode active material can be decreased.

As the conduction aid, any material which is itself an electron conductor and does not cause chemical reaction with any other material in a battery device can be used. As the conduction aid, for example, a carbon-based material such as graphite, carbon fiber, carbon black, acetylene black, and VGCF (registered trademark); a metal material such as copper, nickel, aluminum, and silver; powder, fiber, and the like of mixtures thereof may be used. The conduction aid is a material that promotes the transmission of carriers between particles of an active material; it is filled between the particles of the active material and ensures electrical conduction.

In the case where LiNiPO₄ is manufactured as the core of the main material of the positive-electrode active material, Li₂CO₃, NiO, and NH₄H₂PO₄ are used as raw materials thereof. In the case where LiCoPO₄ is manufactured, Li₂CO₃, CoO, and (NH₄)₂HPO₄ are used as raw materials thereof. In the case where LiMnPO₄ is manufactured, Li₂CO₃, MnCO₃, and NH₄H₂PO₄ are used as raw materials thereof. In the case where Li₃V₂(PO₄)₃ is manufactured, Li₂CO₃, V₂O₅, and NH₄H₂PO₄ are used as raw materials thereof. The above-described raw materials of the main material of the positive-electrode active material are examples, and do not limit the construction of one embodiment of the present invention.

Through the above process, a positive-electrode active material with high electrical conductivity, in which graphene is used as the covering layer can be obtained.

According to this embodiment, a positive-electrode active material with sufficient electrical conductivity can be manufactured with no conduction aid or an extremely small amount of conduction aid.

Further, with the graphene oxide, the hole through which a lithium ion can pass can be formed in the graphene, so that insertion/extraction of an lithium ion into or from the power storage device using the positive-electrode active material of this embodiment is facilitated, resulting in improvement of the charge/discharge rate of the power storage device, which enables electrical charging/discharging in a short period of time.

Accordingly, a positive-electrode active material with high use efficiency of current, a positive-electrode active material with large capacity per unit area, and a power storage device using the positive-electrode active material can be provided.

This embodiment can be combined with any other embodiment as appropriate.

### Embodiment 3

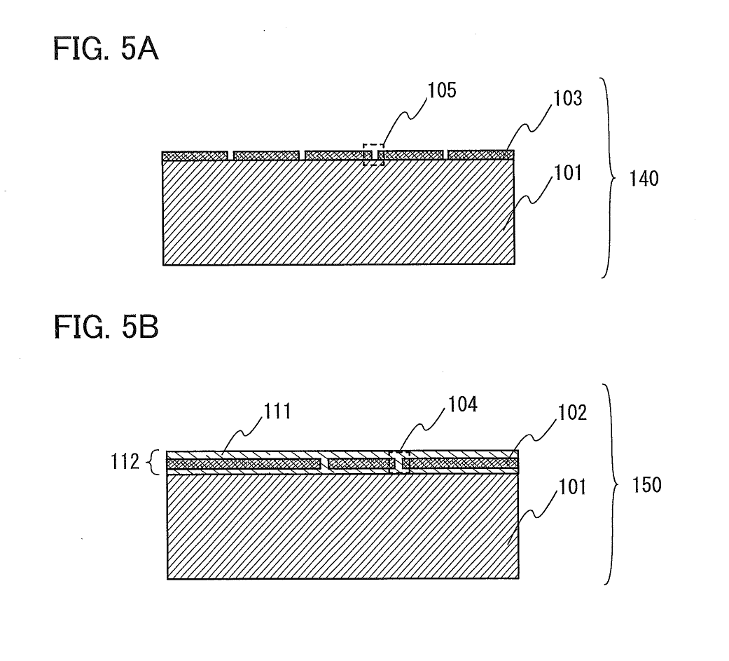

In this embodiment, other forms of the positive-electrode active material described in Embodiment 1 will be described. FIGS. 5A and 5B are cross-sectional views of a positive-electrode active material 140 and a positive-electrode active material 150 which are other embodiments of the present invention.

FIGS. 5A and 5B are modification examples of FIG. 1A; thus, the same reference numerals denote similar functions, and detailed description thereof is omitted.

The positive-electrode active material 140 shown in FIG. 5A includes a core 101 containing lithium metal oxide as a main component, a covering layer 103 which covers the core 101, and a space 105 formed in the covering layer 103.

The covering layer 103 is formed using one to ten pieces of nanographene. Nanographene is graphene whose bonding is cut in the planar direction, and has a length per side in the planar direction of greater than or equal to several nanometers and less than several hundred nanometers, preferably that of greater than or equal to several nanometers and less than several tens of nanometers.

The covering layer 102 shown in FIG. 1A covers the core 101 entirely (except the hole 104), that is the main material of the positive-electrode active material. On the other hand, the covering layer 103 does not cover all surface of the core 101 that is the main material of the positive-electrode active material. With the plural pieces of nanographene as the covering layer 103, the space 105 is formed between nanographene and the plural pieces of nanographene are partly in contact with each other on a surface of the core 101. The space 105 has an effect similar to that of the hole 104 formed by bonding an oxygen atom to part of carbon atoms in the graphene.

In FIG. 5A, the core 101 which is a main component of the positive-electrode active material 140, the covering layer 103, and the space 105 are collectively referred to as a positive-electrode active material.

The covering layer 103 is provided as shown in FIG. 5A, whereby the electrical conductivity of the positive-electrode active material 140 can be improved. Further, the positive-electrode active materials 140 are in contact with each other with the covering layers 103 provided therebetween, whereby the positive-electrode active materials 140 are electrically connected to each other, which leads to further improvement in the electrical conductivity of the positive-electrode active material 140.

The positive-electrode active material 150 shown in FIG. 5B includes a core 101 containing lithium metal oxide as a main component, and a covering layer 112 which covers the core 101.

The covering layer 112 includes a covering layer 102 and a covering layer 111; the covering layer 102 is the graphene described in the above embodiment and the covering layer 111 is formed using amorphous carbon. That is, the covering layer 112 has a structure in which the covering layer 111 that is amorphous carbon includes graphene that is the covering layer 102.

Like the covering layer 102 shown in FIG. 1A, the covering layer 102 has a hole 104 formed by bonding an oxygen atom to part of carbon atoms in the graphene.

In FIG. 5B, the core 101 which is a main component of the positive-electrode active material 150 and the covering layer 112 are collectively referred to as a positive-electrode active material.

The covering layer 102 in the covering layer 112 may be used as the covering layer 103 shown in FIG. 5A; in that case, a space 105 is formed.

The covering layer 112 is provided as shown in FIG. 5B, whereby the electrical conductivity of the positive-electrode active material 150 can be improved. Further, the positive-electrode active materials 150 are in contact with each other with the covering layers 112 provided therebetween, whereby the positive-electrode active materials 150 are electrically connected to each other, which leads to further improvement in the electrical conductivity of the positive-electrode active material 150.

As described above, the provision of the covering layer containing nanographene or graphene enables the electrical conductivity of the positive-electrode active material to be improved.

Further, with the space or hole through which a lithium ion can pass provided in the nanographene or graphene, insertion/extraction of an lithium ion into or from the power storage device using the positive-electrode active material of this embodiment is facilitated, resulting in improvement of the charge/discharge rate of the power storage device, which enables electrical charging/discharging in a short period of time.

Accordingly, a positive-electrode active material with high use efficiency of current, a positive-electrode active material with large capacity per unit area, and a power storage device using the positive-electrode active material can be provided.

This embodiment can be combined with any other embodiment as appropriate.

### Embodiment 4

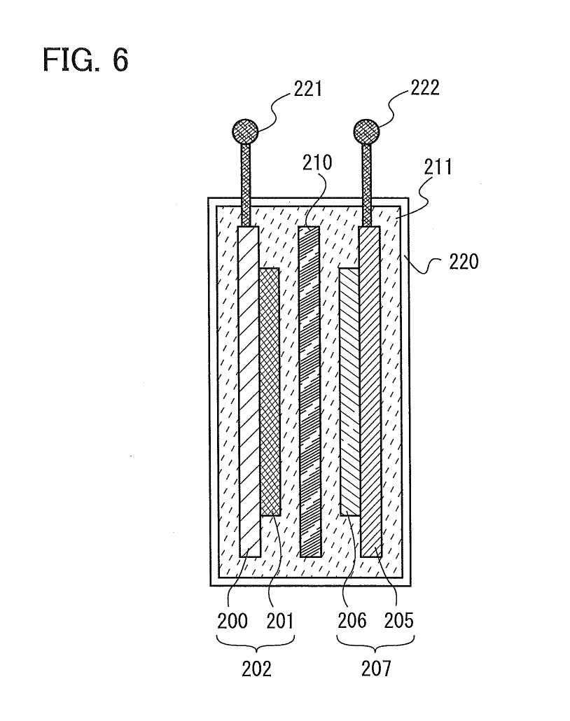

In this embodiment, a lithium-ion secondary battery using any of the positive-electrode active materials described in Embodiments 1 to 3 will be described. The schematic structure of the lithium-ion secondary battery is illustrated in FIG. 6.

In the lithium-ion secondary battery shown in FIG. 6, a positive electrode 202, a negative electrode 207, and a separator 210 are provided in a housing 220 which is isolated from the outside, and the housing 220 is filled with an electrolyte solution 211. In addition, the separator 210 is provided between the positive electrode 202 and the negative electrode 207.

The positive electrode 202 includes a positive-electrode current collector 200 and a positive-electrode active material 201, and the negative electrode 207 includes a negative-electrode current collector 205 and a negative-electrode active material 206.

A first electrode 221 and a second electrode 222 are connected to the positive-electrode current collector 200 and the negative-electrode current collector 205, respectively, and are charged and discharged through the first electrode 221 and the second electrode 222. Although there are certain gaps between the positive-electrode active material 201 and the separator 210 and between the negative-electrode active material 206 and the separator 210 in FIG. 6, one embodiment of the present invention is not particularly limited thereto; the positive-electrode active material 201 may be in contact with the separator 210, and the negative-electrode active material 206 may be in contact with the separator 210. Further, the lithium-ion secondary battery may be rolled into a cylinder shape with the separator 210 provided between the positive electrode 202 and the negative electrode 207.

In this specification, the positive-electrode active material 201 and the positive-electrode current collector 200 provided with the positive-electrode active material 201 are collectively referred to as the positive electrode 202. The negative-electrode active material 206 and the negative-electrode current collector 205 provided with the negative-electrode active material 206 are collectively referred to as the negative electrode 207.

As the positive-electrode current collector 200, a material having high conductivity such as aluminum or stainless steel can be used. The positive-electrode current collector 200 can have a foil shape, a plate shape, a net shape, or the like as appropriate.

As the positive-electrode active material 201, the positive-electrode active material 100 shown in FIG. 1A, the positive-electrode active material 140 shown in FIG. 5A, or the positive-electrode active material 150 shown in FIG. 5B can be used.

In this embodiment, aluminum foil is used as the positive-electrode current collector 200, over which the positive-electrode active material 201 is formed using the method described in Embodiment 2. The thickness of the positive-electrode active material 201 is determined as appropriate to a thickness of 20 μm to 100 μm. It is preferable to adjust the thickness of the positive-electrode active material 201 as appropriate so that neither crack nor separation occurs. Further, it is preferable that neither crack nor separation occurs on the positive-electrode active material 201 not only when the positive-electrode current collector is flat but also when the positive-electrode current collector is rolled into a cylinder shape, though it depends on the form of the lithium-ion secondary battery.

As the negative-electrode current collector 205, a material having high conductivity such as copper, stainless steel, iron, or nickel can be used.

As the negative-electrode active material 206, lithium, aluminum, graphite, silicon, germanium, or the like is used. The negative-electrode active material 206 may be formed over the negative-electrode current collector 205 by a coating method, a sputtering method, an evaporation method, or the like. Any of the materials may be used alone as the negative-electrode active material 206. The theoretical lithium occlusion capacity is larger in germanium, silicon, lithium, and aluminum than graphite. When the occlusion capacity is large, charging and discharging can be performed sufficiently even with a small area as a negative electrode, which leads to cost reduction and miniaturization of the secondary battery. However, in the case of silicon or the like, the volume is increased by lithium occlusion to about 4 times as large as the volume before the lithium occlusion; therefore, it is necessary to pay attention to the risk of explosion, the probability that the material itself gets vulnerable, and the like.

The electrolyte solution 211 contains an alkali metal ion which is a carrier ion, and this carrier ion is responsible for electric conduction. As an example of the alkali metal ion, a lithium ion is given, for example.

The electrolyte solution 211 includes, for example, a solvent and a lithium salt dissolved in the solvent. Examples of the lithium salt include lithium chloride (LiCl), lithium fluoride (LiF), lithium perchlorate (LiClO₄), lithium tetrafluoroborate (LiBF₄), LiAsF₆, LiPF₆, and Li(C₂F₅SO₂)₂N.

Examples of the solvent for the electrolyte solution 211 include cyclic carbonates (e.g., ethylene carbonate (hereinafter abbreviated to EC), propylene carbonate (PC), butylene carbonate (BC), and vinylene carbonate (VC)); acyclic carbonates (e.g., dimethyl carbonate (DMC), diethyl carbonate (DEC), ethylmethyl carbonate (EMC), methylpropyl carbonate (MPC), isobutyl methyl carbonate, and dipropyl carbonate (DPC)); aliphatic carboxylic acid esters (e.g., methyl formate, methyl acetate, methyl propionate, and ethyl propionate); acyclic ethers (e.g., 1,2-dimethoxyethane (DME), 1,2-diethoxyethane (DEE), ethoxymethoxy ethane (EME), and g-lactones such as g-butyrolactone); cyclic ethers (e.g., tetrahydrofuran and 2-methyltetrahydrofuran); cyclic sulfones (e.g., sulfolane); alkyl phosphate ester (e.g., dimethylsulfoxide and 1,3-dioxolane, and trimethyl phosphate, triethyl phosphate, and trioctyl phosphate); and fluorides thereof. Any of the above solvents can be used alone or in combination.

As the separator 210, paper, nonwoven fabric, a glass fiber, a synthetic fiber such as nylon (polyamide), vinylon (also called vinalon) (a polyvinyl alcohol based fiber), polyester, acrylic, polyolefin, or polyurethane, or the like may be used. Note that a material which does not dissolve in the above-described electrolyte solution 211 is selected.

More specific examples of a material of the separator 210 are fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, and nonwoven fabric. Any of the above materials can be used alone or in combination.

When the lithium-ion secondary battery described above is charged, a positive-electrode terminal is connected to the first electrode 221 and a negative-electrode terminal is connected to the second electrode 222. An electron is taken away from the positive electrode 202 through the first electrode 221 and transferred to the negative electrode 207 through the second electrode 222. In addition, a lithium ion is eluted from the active material in the positive-electrode active material 201 from the positive electrode 202, reaches the negative electrode 207 through the separator 210, and is taken in the active material in the negative-electrode active material 206. The lithium ion and the electron are aggregated in that region and are occluded in the negative-electrode active material 206. In the positive-electrode active material 201, an electron is released out from the active material, and triggers an oxidation reaction with a metal contained in the active material.

At the time of discharging, in the negative electrode 207, the negative-electrode active material 206 releases lithium as an ion, and an electron is transferred to the second electrode 222. The lithium ion passes through the separator 210, reaches the positive-electrode active material 201, and is taken in the active material the positive-electrode active material 201. At that time, the electron from the negative electrode 207 also reaches the positive electrode 202, and triggers a reduction reaction with the metal.

The lithium-ion secondary battery manufactured in this manner includes a lithium metal compound as a core of the main material of the positive-electrode active material. Further, the lithium metal compound is covered with a covering layer formed using graphene, which improves the electrical conductivity of the positive-electrode active material. Further, the hole is formed in the covering layer, through which a lithium ion can readily pass from the lithium metal compound that is the core of the main material of the positive-electrode active material. Therefore, a lithium-ion secondary battery with high discharge capacity, which is charged and discharged at high rate can be obtained according to this embodiment.

Accordingly, a positive-electrode active material with high use efficiency of current, and a positive-electrode active material with large capacity per unit area can be manufactured.

The structure, method, and the like described in this embodiment can be combined as appropriate with any of the structures, methods, and the like described in the other embodiments.

### Embodiment 5

In this embodiment, an application example of the power storage device described in the above-described embodiment will be described.

The power storage device described in the above-described embodiment can be used for electronic devices such as cameras like digital cameras or video cameras, mobile phones (also referred to as cellular phones or cellular phone devices), digital photo frames, portable game machines, portable information terminals, and audio reproducing devices. Further, the power storage device can be used for electric propulsion vehicles such as electric vehicles, hybrid vehicles, train vehicles, maintenance vehicles, carts, wheelchairs, and bicycles.

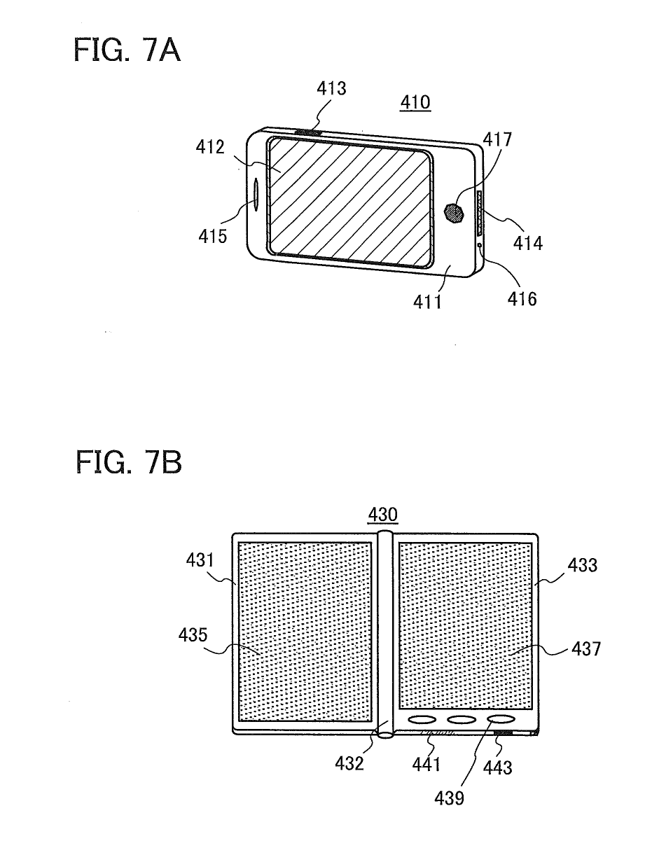

FIG. 7A illustrates an example of a mobile phone handset. In a mobile phone 410, a display portion 412 is incorporated in a housing 411. The housing 411 is provided with an operation button 413, an operation button 417, an external connection port 414, a speaker 415, a microphone 416, and the like.

FIG. 7B illustrates an example of an e-book reader. An e-book reader 430 includes two housings, a first housing 431 and a second housing 433, which are combined with each other with a hinge 432. The first and second housings 431 and 433 can be opened and closed with the hinge 432 as an axis. A first display portion 435 and a second display portion 437 are incorporated in the first housing 431 and the second housing 433, respectively. In addition, the second housing 433 is provided with an operation button 439, a power switch 443, a speaker 441, and the like.

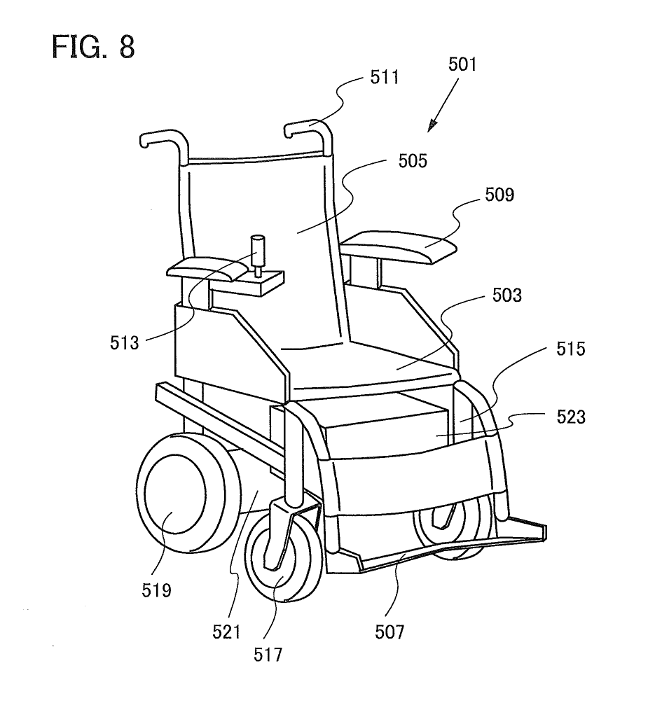

FIG. 8 is a perspective view of an electric wheelchair 501. The electric wheelchair 501 includes a seat 503 where a user sits down, a backrest 505 provided behind the seat 503, a footrest 507 provided at the front of and below the seat 503, armrests 509 provided on the left and right of the seat 503, and a handle 511 provided above and behind the backrest 505. A controller 513 for controlling the operation of the wheelchair is provided for one of the armrests 509. A pair of front wheels 517 is provided at the front of and below the seat 503 through a frame 515 provided below the seat 503, and a pair of rear wheels 519 is provided behind and below the seat 503. The rear wheels 519 are connected to a driver portion 521 including a motor, a brake, a gear, and the like. A control portion 523 including a battery, a power controller, a control means, and the like is provided under the seat 503. The control portion 523 is connected to the controller 513 and the driving portion 521. The driving portion 521 is driven through the control portion 523 with the operation of the controller 513 by the user to control the operation of moving forward, moving back, turning around, and the like, and the speed of the electric wheelchair 501.

The power storage device described in the above-described embodiment can be used for the battery of the control portion 523. The battery of the control portion 523 can be charged by power supply from the outside using a plug-in system.

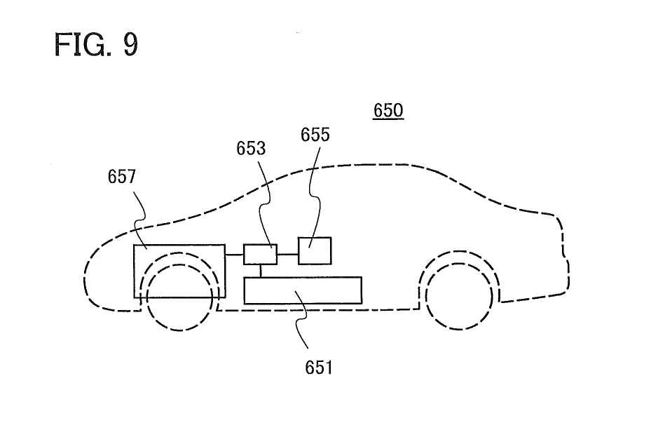

FIG. 9 illustrates an example of an electric vehicle. An electric vehicle 650 is equipped with a power storage device 651. The output of the electric power of the power storage device 651 is controlled by a control circuit 653 and is supplied to a driving device 657. The control circuit 653 is controlled by a computer 655.

The driving device 657 includes a DC motor or an AC motor either alone or in combination with a motor and an internal-combustion engine. The computer 655 outputs a control signal to the control circuit 653 in response to input data such as data of a driver's operation (e.g., acceleration, deceleration, or stop) and data during driving (e.g., data of an upgrade or a downgrade or data of a load on a driving wheel) of the electric vehicle 650. The control circuit 653 adjusts the electric energy supplied from the power storage device 651 in response to the control signal of the computer 655 to control the output of the driving device 657. In the case where the AC motor is mounted, an inverter which converts direct current into alternate current is provided.

The power storage device described in the above-described embodiment can be used for the battery of the power storage device 651. The power storage device 651 can be charged by electric power supply from the outside using a plug-in system.

In the case where the electric propulsion vehicle is a train vehicle, the train vehicle can be charged by power supply from an overhead cable or a conductor rail.

This embodiment can be combined with any other embodiment as appropriate.

### EXPLANATION OF REFERENCE

100: positive-electrode active material; 101: core; 102: covering layer; 103: covering layer; 104: hole; 105: space; 106: carbon atom; 108: oxygen atom; 110: lithium ion; 111: covering layer; 112: covering layer; 122: covering layer; 140: positive-electrode active material; 150: positive-electrode active material; 200: positive-electrode current collector; 201: positive-electrode active material; 202: positive electrode; 205: negative-electrode current collector; 206: negative-electrode active material; 207: negative electrode; 210: separator; 211: electrolyte solution; 220: housing; 221: electrode; 222: electrode; 410: mobile phone; 411: housing; 412: display portion; 413: operation bottom; 414: external connection port; 415: speaker; 416: microphone; 417: operation bottom; 430: e-book reader; 431: housing; 432: hinge; 433: housing; 435: display portion; 437: display portion; 439: operation bottom; 441: speaker; 443: power switch; 501: electric wheelchair; 503: seat; 505: backrest; 507: footrest; 509: armrest; 511: handle; 513: controller; 515: frame; 517: front wheel; 519: rear wheel; 521: driver portion; 523: control portion; 650: electric vehicle; 651: power storage device; 653: control circuit; 655: computer; 657: driving device

This application is based on Japanese Patent Application serial no. 2010-228634 filed with Japan Patent Office on Oct. 8, 2010, the entire contents of which are hereby incorporated by reference.

1. A method for manufacturing a power storage device comprising:
forming a first mixture by mixing raw materials including lithium;
baking the first mixture at a temperature in a range of 250° C. to 450° C. for 1 to 48 hours;
adding a graphene oxide to the first mixture that is baked to form a second mixture; and
baking the second mixture at a temperature in a range of 500° C. to 800° C. for 1 to 48 hours in an inactive gas atmosphere, a reducing gas atmosphere or a vacuum to form a positive-electrode active material,
wherein the positive-electrode active material includes a core including lithium metal oxide and a covering layer which covers the core and comprises a structure that one to ten pieces of graphene are stacked, and
wherein each piece of graphene comprises a hole surrounded with both of carbon atoms and oxygen atoms which are covalently bonded to the carbon atoms.

2. The method for manufacturing a power storage device according to claim 1, wherein the hole is surrounded with three oxygen atoms each of which is bonded to two nearest carbon atoms.

3. The method for manufacturing a power storage device according to claim 1, wherein the covering layer includes amorphous carbon.

4. The method for manufacturing a power storage device according to claim 1, wherein the lithium metal oxide is one of Li₂FeSiO₄ and Li₂MnSiO₄.

5. The method for manufacturing a power storage device according to claim 1, wherein there is no space between the core and the covering layer.

6. The method for manufacturing power storage device according to claim 1, wherein a size of the core is 50 nm or less.

7. A method for manufacturing a power storage device comprising:
forming a first mixture by mixing raw materials including lithium;
baking the first mixture at a temperature in a range of 250° C. to 450° C. for 1 to 48 hours;
adding a graphene oxide to the first mixture that is baked to form a second mixture; and
baking the second mixture at a temperature in a range of 500° C. to 800° C. for 1 to 48 hours to form a positive-electrode active material,
wherein the positive-electrode active material includes a core including lithium metal oxide and a covering layer which covers the core and comprises a structure that one to ten pieces of graphene are stacked, and
wherein each piece of graphene comprises a hole surrounded with both of carbon atoms and oxygen atoms which are covalently bonded to the carbon atoms.

8. The method for manufacturing a power storage device according to claim 7, wherein the hole is surrounded with three oxygen atoms each of which is bonded to two nearest carbon atoms.

9. The method for manufacturing a power storage device according to claim 7, wherein the covering layer includes amorphous carbon.

10. The method for manufacturing a power storage device according to claim 7, wherein the lithium metal oxide is one of Li₂FeSiO₄ and Li₂MnSiO₄.

11. The method for manufacturing a power storage device according to claim 7, wherein there is no space between the core and the covering layer.

12. The method for manufacturing power storage device according to claim 7, wherein a size of the core is 50 nm or less.

13. A method for manufacturing a power storage device comprising:
forming a first mixture by mixing raw materials including lithium;
baking the first mixture at a temperature in a range of 250° C. to 450° C. for 1 to 48 hours;
crushing the first mixture that is baked so that a grain size of the first mixture is 50 nm or less;
adding a graphene oxide to the first mixture that is crushed to form a second mixture; and
baking the second mixture at a temperature in a range of 500° C. to 800° C. for 1 to 48 hours to form a positive-electrode active material,
wherein the positive-electrode active material includes a core including lithium metal oxide and a covering layer which covers the core and comprises a structure that one to ten pieces of graphene are stacked, and
wherein each piece of graphene comprises a hole surrounded with both of carbon atoms and oxygen atoms which are covalently bonded to the carbon atoms.

14. The method for manufacturing a power storage device according to claim 13, wherein the hole is surrounded with three oxygen atoms each of which is bonded to two nearest carbon atoms.

15. The method for manufacturing a power storage device according to claim 13, wherein the covering layer includes amorphous carbon.

16. The method for manufacturing a power storage device according to claim 13, wherein the lithium metal oxide is one of Li₂FeSiO₄ and Li₂MnSiO₄.

17. The method for manufacturing a power storage device according to claim 13, wherein there is no space between the core and the covering layer.

18. The method for manufacturing power storage device according to claim 13, wherein a size of the core is 50 nm or less.
